(19) United States
(12) Patent Application Publication
(10) Pub. No.: US 2018/0015654 A1
(43) Pub. Date: Jan. 18, 2018

(54) MANUFACTURING METHOD OF SEAMLESS STRIP

(71) Applicant: SWO-CHUNG CHAI, TAIPEI CITY (TW)

(72) Inventor: SWO-CHUNG CHAI, TAIPEI CITY (TW)

(21) Appl. No.: 15/211,323

(22) Filed: Jul. 15, 2016

(51) Int. Cl. B29C 47/00; B29L 31/00; B29K 27/06; B29K 75/00

(52) U.S. Cl. CPC B29C 47/0066; B29C 47/0026; B29K 2075/00; B29C 2793/009; B29L 2031/751; B29K 2027/06

(57) ABSTRACT

A manufacturing method of a seamless strip of the invention includes: filling plastic material into an extruding machine; extruding the plastic material through the extruding machine; forming a thin tubular body; and cutting the thin tubular body to form a seamless strip.

### FIELD OF THE INVENTION

The invention relates to a manufacturing method of a strip, and more particularly to a manufacturing method of seamless strip.

### BACKGROUND OF THE INVENTION

Inflatable mattresses are so popular due to their comfortable, soft and warm characteristics. Conventional inflatable mattresses have air bags. Air is pumped into or discharged from the air bags through valves mounted on a lateral side of the inflatable mattresses. When the inflatable mattress is filled with air, the inflatable mattress is inflated and a user can sit on it or lie on it. When air is discharged from the inflatable mattress through the valve, the volume of the inflatable mattress is reduced, and the inflatable mattress is easily to be packed.

Referring to FIG. 1, a conventional inflatable mattress 10 includes an upper layer 11 constituting a surface of the inflatable mattress 10, a lower layer 12 constituting a bottom of the inflatable mattress 10, a lateral layer 13 connecting the upper layer 11 and the lower layer 12 to constitute a periphery of the inflatable mattress 10. The upper layer 10, the lower layer 12 and the lateral layer 13 form an inner space. Several strips 14 are disposed in the inner space and connect the upper layer 10 and the lower layer 12. The strips pull the upper layer 10 and the lower layer 12 and maintain a shape of the inflatable mattress 10 when the inflatable mattress 10 is fully filled with air.

However, the strip 14 is made by welding two PVC sheets through high frequency. As shown in FIG. 2, the conventional strip 14 has welding traces 141 on two lateral sides which bulge material of the strip 14 and causes a low strength.

### SUMMARY OF THE INVENTION

An object of the invention is to provide a manufacturing method of a seamless strip. Plastic material is extruded by an extruding machine to form a thin tubular body. The thin tubular body is cut to form a seamless strip which has an excellent strength, not easily to be broken and causes low labor and less time for manufacturing.

The invention provides a manufacturing method of a seamless strip. The manufacturing method of a seamless strip in accordance with an exemplary embodiment of the invention includes: filling plastic material into an extruding machine; extruding the plastic material through the extruding machine; forming a thin tubular body; and cutting the thin tubular body to form a seamless strip.

In another exemplary embodiment, the manufacturing method of a seamless strip further includes the following step: receiving the thin tubular body to a space.

In yet another exemplary embodiment, the seamless strip is used in an inflatable mattress.

In another exemplary embodiment, the plastic material is thermoplastic polyurethane (TPU).

In yet another exemplary embodiment, the plastic material is polyvinyl chloride (PVC).

In another exemplary embodiment, a thickness of thin tubular body ranges from 0.10 mm to 1.00 mm.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a conventional strip applied to an inflatable mattress;

FIG. 2 is a schematic view of a conventional strip;

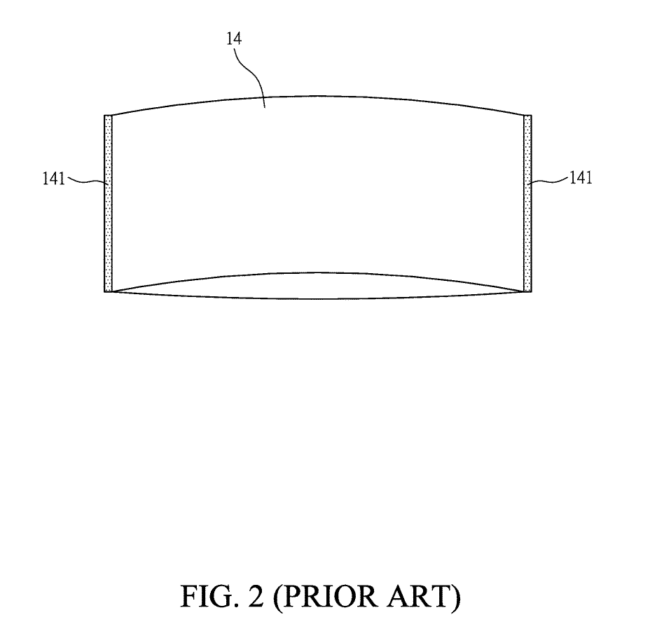

FIG. 3 is a flow chart of a manufacturing method of a seamless strip of the invention;

FIG. 4 is a schematic view of a tubular body of the invention; and

FIG. 5 is a schematic view of a seamless strip of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

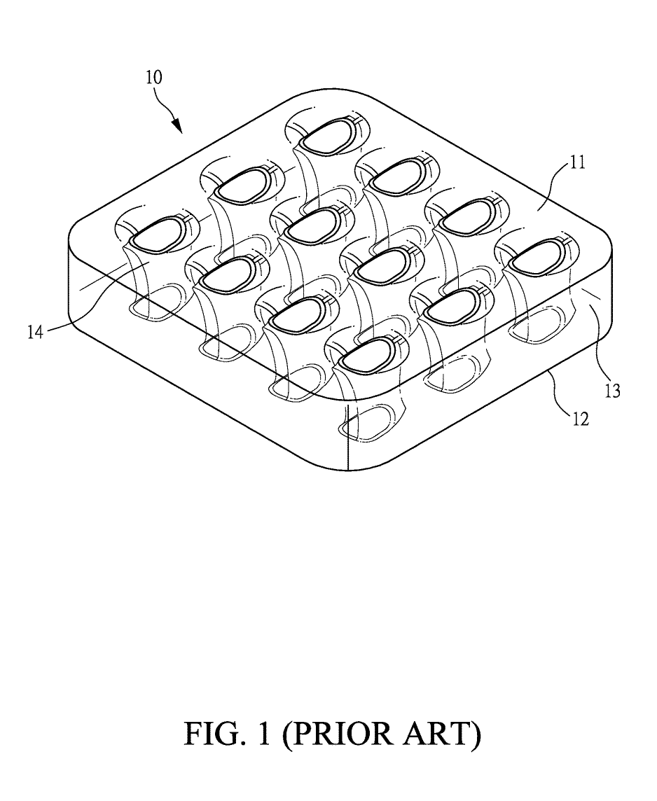

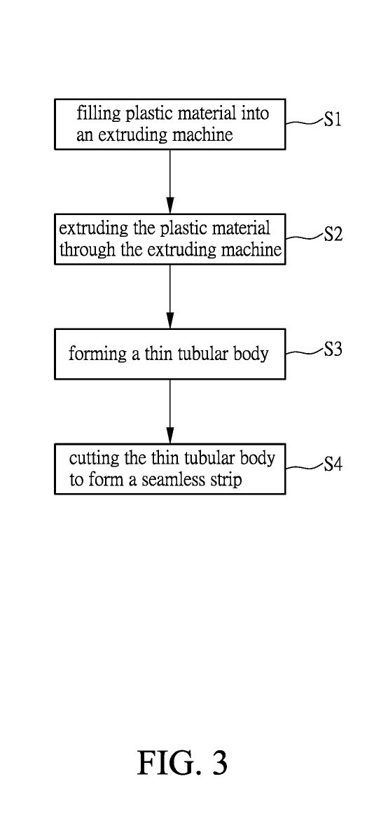

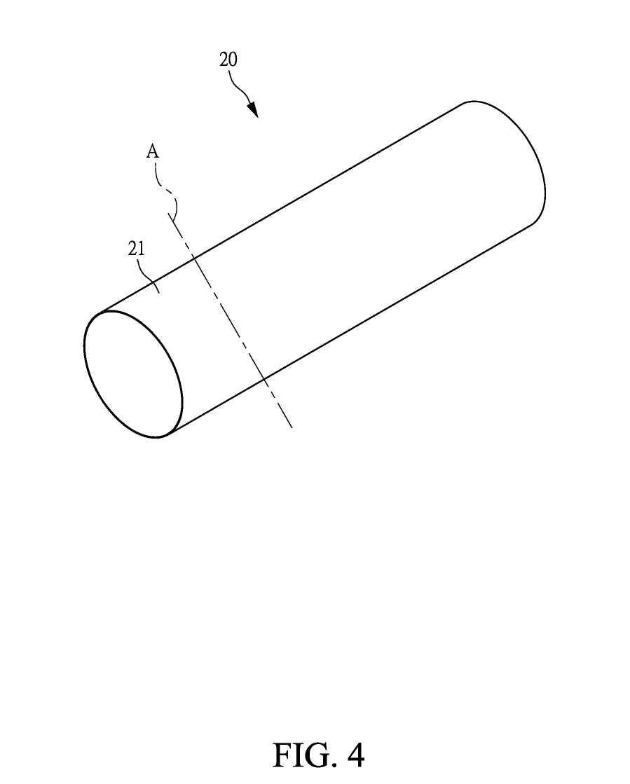

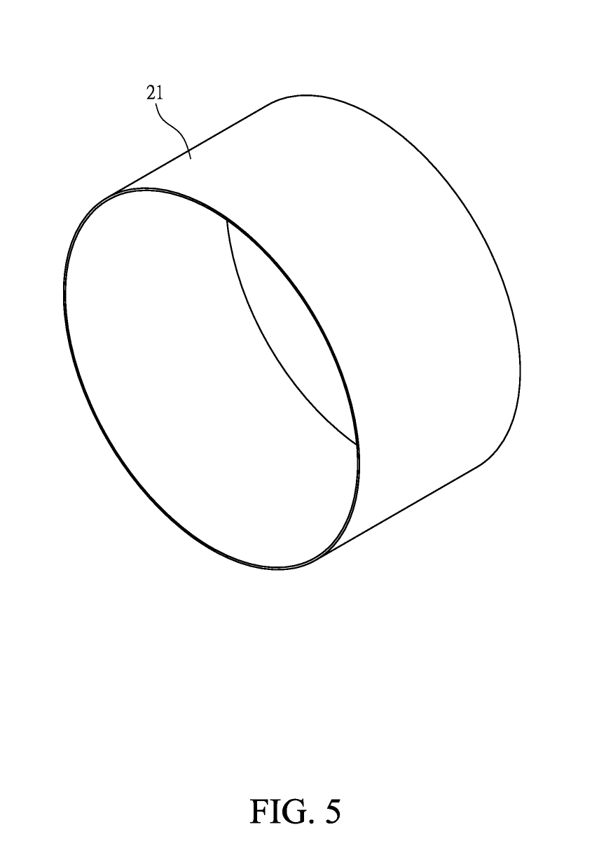

Referring to FIGS. 3 to 5, a manufacturing method of seamless strip includes the following steps: in a step S1, plastic material is filled into a extruding machine; in a step S2, the extruding machine extrudes the plastic material; in a step S3, the extruded plastic material forms a thin tubular body 20 which has a thickness ranges from 0.10 mm to 1.00 mm; and in a step S4, the thin tubular body is cut along a line A to form a seamless strip 21 which can be applied to an inflatable mattress 10 as shown in FIG. 1 or other products need strip.

The plastic material filled into the extruding machine in the step S1 is thermoplastic polyurethane (TPU) or polyvinyl chloride (PVC).

After the thin tubular body 20 is formed in the step S3, the thin tubular body 20 is rolled and placed in a space (not shown). When the seamless strip 21 is to be manufactured, the thin tubular body 20 is taken from the space and cut.

The invention provides a manufacturing method of seamless strip, wherein plastic material is filled into an extruding machine, the extruding machine extrudes the plastic material to form a thin tubular body, and the thin tubular body is cut to form the seamless strip. The seamless strip has an excellent strength, not easily to be broken and causes low labor and less time for manufacturing.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A manufacturing method of seamless strip, comprising:
filling plastic material into an extruding machine;
extruding the plastic material through the extruding machine;
forming a thin tubular body; and
cutting the thin tubular body to form a seamless strip.

2. The manufacturing method as claimed in claim 1 further comprising:
receiving the thin tubular body to a space.

3. The manufacturing method as claimed in claim 1, wherein the seamless strip is used in an inflatable mattress.

4. The manufacturing method as claimed in claim 1, wherein the plastic material is thermoplastic polyurethane (TPU).

5. The manufacturing method as claimed in claim 1, wherein the plastic material is polyvinyl chloride (PVC).

6. The manufacturing method as claimed in claim 1, wherein a thickness of thin tubular body ranges from 0.10 mm to 1.00 mm.

7. The manufacturing method as claimed in claim 2, wherein the plastic material is thermoplastic polyurethane (TPU).

8. The manufacturing method as claimed in claim 2, wherein the plastic material is polyvinyl chloride (PVC).

9. The manufacturing method as claimed in claim 2, wherein a thickness of thin tubular body ranges from 0.10 mm to 1.00 mm.

10. The manufacturing method as claimed in claim 3, wherein the plastic material is thermoplastic polyurethane (TPU).

11. The manufacturing method as claimed in claim 3, wherein the plastic material is polyvinyl chloride (PVC).

12. The manufacturing method as claimed in claim 3, wherein a thickness of thin tubular body ranges from 0.10 mm to 1.00 mm.
